(19) United States
(12) Patent Application Publication
(10) Pub. No.: US 2026/0105844 A1
(43) Pub. Date: Apr. 16, 2026

(54) EMERGENCY-AWARE RISK TREATMENT AND CONTINGENCY MANEUVERS

(71) Applicant: INTERNATIONAL BUSINESS MACHINES CORPORATION, Armonk, NY (US)

(72) Inventors: Li Bo Zhang, Bei Jing (CN); Rong Zhao, Beijing (CN); Zhe Yan, Beijing (CN); Li Li Guan, Beijing (CN); Hao Xiang Wu, Beijing (CN); Su Liu, Austin, TX (US)

(21) Appl. No.: 18/914,027

(22) Filed: Oct. 11, 2024

(51) Int. Cl. G08G 1/16; G08G 1/01; G08G 1/0967

(52) U.S. Cl. CPC G08G 1/161; G08G 1/0112; G08G 1/0133; G08G 1/096725; G08G 1/166

(57) ABSTRACT

A computer-implemented method may include receiving regional traffic data, vehicle exterior data, and vehicle interior data; identifying a risk associated with the regional traffic data, the vehicle exterior data, and the vehicle interior data; generating a regional traffic internet-of-vehicles (IoV) model based on the risk, the regional traffic data, the vehicle exterior data, and the vehicle interior data; identifying a contingency maneuver based on the regional traffic IoV model; communicating instructions comprising the contingency maneuver to a user device associated with the IoV network, wherein the instructions cause the user device to display the contingency maneuver; and sending an instruction to a target vehicle that causes the target vehicle to perform the contingency maneuver.

### BACKGROUND

Aspects of the present invention relate generally to automatically implementing, real-time contingency maneuvers during driving.

Advanced driver assistance systems (ADAS) may perform functions such as automatic acceleration, braking, turning, etc., to avoid collisions and effectively reduce the number of accidents caused by reduced visibility or driver impairment.

### SUMMARY

In a first aspect of the invention, there is a computer-implemented method including: receiving regional traffic data, vehicle exterior data, and vehicle interior data; identifying a risk associated with the regional traffic data, the vehicle exterior data, and the vehicle interior data; generating a regional traffic internet-of-vehicles (IoV) model based on the risk, the regional traffic data, the vehicle exterior data, and the vehicle interior data; identifying a contingency maneuver based on the regional traffic IoV model; and communicating instructions comprising the contingency maneuver to a user device associated with the IoV network, wherein the instructions cause the user device to display the contingency maneuver; and sending an instruction to a target vehicle that causes the target vehicle to perform the contingency maneuver.

In another aspect of the invention, there is a computer program product including one or more computer readable storage media having program instructions collectively stored on the one or more computer readable storage media. The program instructions are executable to: receive regional traffic data, vehicle exterior data, and vehicle interior data; identify a risk associated with the regional traffic data, the vehicle exterior data, and the vehicle interior data; generate a regional traffic internet-of-vehicles (IoV) model based on the risk, the regional traffic data, the vehicle exterior data, and the vehicle interior data; identify a contingency maneuver based on the regional traffic IoV model; communicate instructions comprising the contingency maneuver to a user device associated with the IoV network, wherein the instructions cause the user device to display the contingency maneuver; and send an instruction to a target vehicle that causes the target vehicle to perform the contingency maneuver.

In another aspect of the invention, there is a system including a processor set, one or more computer readable storage media, and program instructions collectively stored on the one or more computer readable storage media. The program instructions are executable to: receive regional traffic data, vehicle exterior data, and vehicle interior data; identify a risk associated with the regional traffic data, the vehicle exterior data, and the vehicle interior data; generate a regional traffic internet-of-vehicles (IoV) model based on the risk, the regional traffic data, the vehicle exterior data, and the vehicle interior data; identify a contingency maneuver based on the regional traffic IoV model; communicate instructions comprising the contingency maneuver to a user device associated with the IoV network, wherein the instructions cause the user device to display the contingency maneuver; and send an instruction to a target vehicle that causes the target vehicle to perform the contingency maneuver.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary method in accordance with aspects of the present invention.

FIG. 4 shows a block diagram of an exemplary environment in accordance with aspects of the present invention.

FIG. 5 shows a block diagram of an exemplary environment in accordance with aspects of the present invention.

FIG. 6 shows a block diagram of an exemplary method in accordance with aspects of the present invention.

FIG. 7 shows a flowchart of an exemplary method in accordance with aspects of the present invention.

FIG. 8 shows a flowchart of an exemplary method in accordance with aspects of the present invention.

### DETAILED DESCRIPTION

Aspects of the present invention relate generally to a vehicle ADAS and, more particularly, to a system, method, or computer program product for emergency-aware risk treatment and contingency maneuvers (ERTCM) in a vehicle. According to aspects of the present invention, an ERTCM system may incorporate both local traffic data and interior and exterior environment conditions into a vehicle ADAS, profile a risk associated with the environmental conditions, identify a corresponding contingency maneuver, execute the contingency maneuver including an emergency avoidance or guidance, and communicate warnings to a user, user device, or vehicle infotainment system. In this manner, implementations of the present invention automatically measure or receive local interior and exterior vehicle and traffic data, identify at least one risk, identify a maneuver to avoid or minimize the at least one risk, and execute the maneuver. In this way, the ERTCM system may improve driver safety and vehicle responsiveness.

Vehicle travel (e.g., passenger vehicle travel) may experience reduced visibility, high-risk road surface conditions, reduced vehicle performance, or driver impairment during extreme weather conditions. For example, severe weather, such as fog, heavy rain, snowfall, etc., will cause visibility to decrease rapidly. Drivers may have difficulty to clearly see the road ahead and other vehicles, such that collisions (e.g., rear-end collisions) are prone to occur. Rain or snow may make the highway road surface slippery, which may cause vehicles to slip or lose control when driving and increase the risk of traffic accidents. In rainy and snowy weather, the vehicle's braking performance and handling performance may be greatly reduced, also resulting in an increased chance of traffic accidents. Severe cold, heavy fog, and other severe weather may impact a driver's psychology and cause fatigue, panic, and other emotions that affect driving behavior and increase the risk of traffic accidents.

In conventional vehicle systems, smart vehicle guidance features like ADAS may help drivers see the road better in poor visibility conditions, such as rain, snow, or fog. ADAS may use light signals to warn drivers and detect vehicles ahead to reduce accidents (e.g., rear-end collisions) caused by low visibility. However, conventional systems struggle with inaccurate positioning and outdated traffic information. Conventional systems often include a heads-up display (HUD) in the vehicle interior, which projects key information like speed and navigation onto the windshield. Accordingly, the HUD allows drivers to see details without looking away from the road. However, the brightness of a HUD can create a strong contrast with environmental surroundings, potentially distracting drivers and creating safety issues. Aspects of the present invention improve the technical field of vehicle ADAS by incorporating local traffic data and interior and exterior environment conditions into vehicle ADAS to identify risks that a driver may not be aware of and present the driver with contingency maneuvers to reduce or eliminate the risk. In embodiments, aspects of the present invention may execute the contingency maneuver to significantly reduce the risk of traffic accidents.

In embodiments, the ERTCM system may incorporate both regional traffic data and interior and exterior environment conditions into real-time vehicle data under the presence of special driving circumstances. The ERTCM system may deduce the traffic conditions and extreme circumstances, identify the vehicle risk and corresponding contingency maneuvers, including emergency avoidance and guidance (e.g., route planning). The ERTCM system may include an internet-of-vehicles (IoV) network functioning as a combination of mobile internet connections of vehicles and the internet-of-things (IoT), where vehicles function as smart, moving intelligent nodes or objects within the network. The IoV may be a network connecting vehicles to other vehicles, the surrounding environment, and vehicle infrastructure. The IoV may provide large-scale vehicle data collection, information processing, storage, and communication to contribute to data associated with the ERTCM system. The ERTCM system may include the collection of or receiving of regionally related traffic information with respect to vehicles implementing the system. The ERTCM system may include the collection of or receiving of extreme weather conditions encountered by nearby vehicles and real-time interpretation of traffic information and road condition information. The ERTCM system may include the collection of or receiving of temperature, humidity, noise, and voice data detection achieved via onboard vehicle sensors including detection of facial gestures, physical movement, perspiration, eye movement, etc. Vehicle sensors may include cameras, radar, gyroscopes, lidar, etc. In some embodiments, the ERTCM system may be configured to identify physical attributes of drivers or passengers that may influence the identification of risk or the prioritization of seeking emergency services.

In embodiments, the ERTCM system may include a risk matrix generated to identify potentially dangerous conditions with the support of multimodal sensor data fusion and intelligent mutual support or rescue contingency maneuvers decision-making. The ERTCM system may incorporate regional traffic data and interior and exterior environment condition parameters into real-time vehicles driving under the presence of special driving circumstances. The ERTCM system may perform risk matrix derivation through regional traffic IoV model computing under extreme driving circumstances, risk matrix ranking movement management reflecting real-time environment changes, and mutual support options. In embodiments, the ERTCM system may be configured to generate instructions communicated to a vehicle or user device, including contingency maneuver recommendations based on a regional traffic IoV model configured to generate emergency avoidance and guidance based on an identified risk. In embodiments, the ERTCM system may include big data and multimedia analysis computation through the analysis and processing of multi-modal data input (audio, video, image, traffic, weather data, etc.) via artificial intelligence modeling technology to classify the severity and likelihood of occurrence of various risks and calculate the risk level of the current data set with respect to a target vehicle. The ERTCM system may use traffic information data from the IoV and real-time visual recognition of cameras of the vehicles, analyze and judge the current traffic conditions, and generate a regional traffic IoV model. The ERTCM system may generate comprehensive warnings, emergency guidance, and contingency maneuvers to passengers and drivers through semantic analysis of conversations, smart wearable devices detect physical parameters, or real-time onboard vehicle cameras visual recognition, derive people adaptability and resolution level, compare the generated artificial intelligence big data risk module to match the current risk acceptance level.

In embodiments, the ERTCM system may establish and maintain a vehicle network model of regional traffic conditions, and analyze and output the risk level within the regional influence radius in real-time. Through real-time analysis and processing of various multi-modal data, and clustering and prediction of data models using artificial intelligence, the ERTCM system may identify possible risks and risk severity level and generate a risk analysis matrix to deal with real-time changes.

In embodiments, the ERTCM system may generate vehicle contingency maneuvers through mutual communication between vehicles through IoV technology. Traffic conditions may dynamically change with time, and the ERTCM system may identify optimal solutions to risks that can be measured and flexibly recommended in real-time. The ERTCM system may also be configured to enhance the silhouette of other vehicles from the driver's perspective, risk warnings within the risk radius in the risk module, and dynamic contingency maneuver reaction, all of which provide guidance and assistance to drivers under emergency.

In embodiments, a computer-implemented method may include receiving regional traffic data, vehicle exterior data, and vehicle interior data; identifying a risk associated with the regional traffic data, the vehicle exterior data, and the vehicle interior data; generating a regional traffic internet-of-vehicles (IoV) model based on the risk, the regional traffic data, the vehicle exterior data, and the vehicle interior data; identifying a contingency maneuver based on the regional traffic IoV model; communicating instructions comprising the contingency maneuver to a user device associated with the IoV network, wherein the instructions cause the user device to display the contingency maneuver; and sending an instruction to a target vehicle that causes the target vehicle to perform the contingency maneuver. Aspects of the present invention improve the safety of vehicle operation by identifying a risk and a contingency maneuver to reduce or eliminate the driving risk.

In embodiments, a computer-implemented method may include regional traffic data comprised of regional traffic within a radius relative to a target vehicle. Aspects of the present invention improve the safety of vehicle operation relative to nearby vehicles.

In embodiments, a computer-implemented method may include vehicle exterior data measured by a sensor external to a target vehicle. Aspects of the present invention improve the safety of vehicle operation, including accounting for external environmental factors.

In embodiments, a computer-implemented method may include vehicle interior data measured by a sensor within the interior of a target vehicle. Aspects of the present invention improve the safety of vehicle operation, including accounting for internal vehicle factors.

In embodiments, a computer-implemented method may include communicating a message to an emergency service vehicle based on the risk and an updated contingency maneuver. Aspects of the present invention improve the safety of vehicle operation, including automatically contacting necessary emergency services.

In embodiments, a computer-implemented method may include updating the regional traffic IoV model based on an updated contingency maneuver. Aspects of the present invention improve the safety of vehicle operation, including updating a regional traffic IoV model with changes in vehicle maneuvers, thereby providing more accurate traffic data.

In embodiments, a computer-implemented method wherein identifying the risk comprises: generating a risk analysis matrix based on the regional traffic data, the vehicle exterior data, and the vehicle interior data; comparing the risk analysis matrix to a risk tolerance threshold; and identifying one or more risks above the risk tolerance threshold. Aspects of the present invention improve the safety of vehicle operation by identifying risks to be avoided based on a comparison to a threshold.

In embodiments, a computer-implemented method wherein the generating the regional traffic IoV model comprises at least one rule describing the interaction between the regional traffic data, the vehicle exterior data, and the vehicle interior data and extrapolating future regional traffic data, the vehicle exterior data, and the vehicle interior data. Aspects of the present invention improve the safety of vehicle operation, including defining the interaction between multiple data sources to better identify risks to a vehicle.

In embodiments, a computer-implemented method wherein identifying the contingency maneuver based on the regional traffic IoV model comprises a rules-based correlation between the risk and contingency maneuvers, wherein the rules-based correlation defines a contingency maneuver to minimize the risk. Aspects of the present invention improve the safety of vehicle operation, including defining the interaction between multiple data sources to better identify risks to a vehicle and identify a corresponding vehicle contingency maneuver to avoid risks over a threshold.

In embodiments, a computer-implemented method wherein identifying the risk comprises classifying the severity and likelihood of an occurrence of the risk to a target vehicle or driver based on the regional traffic data, the vehicle exterior data, and the vehicle interior data. Aspects of the present invention improve the safety of vehicle operation, including identifying the likelihood of a risk occurring, thereby improving the likelihood that a risk may be avoided.

In embodiments, a computer-implemented may include communicating the risk and the contingency maneuver to an IoV network; generating an updated contingency maneuver in response to receiving feedback data from the IoV network; and communicating instructions comprising the updated contingency maneuver to a user device associated with the IoV network, wherein the instructions cause the user device to display the updated contingency maneuver. Aspects of the present invention improve the safety of vehicle operation by identifying new contingency maneuvers that may be necessary to avoid new or changing risks.

In embodiments, a computer program product comprising one or more computer readable storage media having program instructions collectively stored on the one or more computer readable storage media, the program instructions executable to: receive regional traffic data, vehicle exterior data, and vehicle interior data; identify a risk associated with the regional traffic data, the vehicle exterior data, and the vehicle interior data; generate a regional traffic internet-of-vehicles (IoV) model based on the risk, the regional traffic data, the vehicle exterior data, and the vehicle interior data; identify a contingency maneuver based on the regional traffic IoV model; communicate instructions comprising the contingency maneuver to a user device associated with the IoV network, wherein the instructions cause the user device to display the contingency maneuver; and send an instruction to a target vehicle that causes the target vehicle to perform the contingency maneuver. Aspects of the present invention improve the safety of vehicle operation by identifying a risk and a contingency maneuver to reduce or eliminate the driving risk.

In embodiments, a computer program product may include regional traffic data comprised of regional traffic within a radius relative to a target vehicle. Aspects of the present invention improve the safety of vehicle operation relative to nearby vehicles.

In embodiments, a computer program product may include vehicle exterior data measured by a sensor external to a target vehicle. Aspects of the present invention improve the safety of vehicle operation, including accounting for external environmental factors. Aspects of the present invention improve the safety of vehicle operation, including accounting for internal vehicle factors.

In embodiments, a computer program product may include vehicle interior data measured by a sensor within the interior of a target vehicle. Aspects of the present invention improve the safety of vehicle operation, including accounting for internal vehicle factors.

In embodiments, a computer program product may include communicating a message to an emergency service vehicle based on the risk and an updated contingency maneuver. Aspects of the present invention improve the safety of vehicle operation, including automatically contacting necessary emergency services.

In embodiments, a computer program product may include updating the regional traffic IoV model based on an updated contingency maneuver. Aspects of the present invention improve the safety of vehicle operation, including updating a regional traffic IoV model with changes in vehicle maneuvers, thereby providing more accurate traffic data.

In embodiments, a computer program product may include identifying the risk comprises: generating a risk analysis matrix based on the regional traffic data, the vehicle exterior data, and the vehicle interior data; comparing the risk analysis matrix to a risk tolerance threshold; and identifying one or more risks above the risk tolerance threshold. Aspects of the present invention improve the safety of vehicle operation by identifying risks to be avoided based on a comparison to a threshold.

In embodiments, a system may include a processor set, one or more computer readable storage media, and program instructions collectively stored on the one or more computer readable storage media, the program instructions executable to receive regional traffic data, vehicle exterior data, and vehicle interior data; identify a risk associated with the regional traffic data, the vehicle exterior data, and the vehicle interior data; generate a regional traffic internet-of-vehicles (IoV) model based on the risk, the regional traffic data, the vehicle exterior data, and the vehicle interior data; identify a contingency maneuver based on the regional traffic IoV model; communicate instructions comprising the contingency maneuver to a user device associated with the IoV network, wherein the instructions cause the user device to display the contingency maneuver; and send an instruction to a target vehicle that causes the target vehicle to perform the contingency maneuver. Aspects of the present invention improve the safety of vehicle operation by identifying a risk and a contingency maneuver to reduce or eliminate the driving risk.

In embodiments, a system may include regional traffic data comprised of regional traffic within a radius relative to a target vehicle. Aspects of the present invention improve the safety of vehicle operation relative to nearby vehicles.

Implementations of the invention involves the technical field of vehicle management systems including managing volumes of data measured and communicated over an IoV network, and are therefore necessarily rooted in computer technology. For example, the steps of generating, by a processor set, a regional traffic IoV model based on a risk, regional traffic data, vehicle exterior data, and vehicle interior data; identifying, by the processor set, a contingency maneuver based on the regional traffic IoV model; communicating, by the processor set, the risk and the contingency maneuver to an IoV network; generating, by the processor set, an updated contingency maneuver in response to receiving feedback data from the IoV network; and communicating, by the processor, instructions comprising the updated contingency maneuver to a user device and a vehicle associated with the IoV network, wherein the instructions cause the user device and the vehicle to display the updated contingency maneuver are computer-based and cannot be performed in the human mind. For example, communicating the risk and the contingency maneuver to an IoV network; generating an updated contingency maneuver in response to receiving feedback data from the IoV network; and communicating instructions comprising the updated contingency maneuver to a user device and a vehicle associated with the IoV network, wherein the instructions cause the user device and the vehicle to display the updated contingency maneuver amounts to more than merely implementing a generic computer as a tool to gather, analyze, and output data. Similarly, implementations of the invention would be impossible to accomplish on pen and paper due to the volume of data being measured, calculated, and communicated over an IoV network in real-time as a vehicle travels. In particular, the speed at which the measuring, calculation, and communication of data, including environmental data, vehicle data, and traffic data determined, in some cases, via global positions systems, occurs in order to effectuate the disclosed method, system, or computer program product would involve large-scale, continuous monitoring, calculation, and wireless communication of such data. These features would be impossible to accomplish on pen and paper and cannot be accomplished as a method of organizing human activity.

Implementations of the invention involve artificial intelligence modeling technology and machine learning to classify the severity and likelihood of occurrence of various risks and calculate the risk level of the current data set with respect to a target vehicle. Training and using a machine learning model are, by definition, performed by a computer and cannot practically be performed in the human mind (or with pen and paper) due to the complexity and massive amounts of calculations involved. Additionally, for example, a machine learning algorithm may be trained using a large amount of historical and real-time data. Thus, the model generates an output in real time (or near real time) based on the historical and real-time data. Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, facial gestures, physical movement, perspiration, eye movement, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

As a non-limiting example, a driver having limited vision capability and physical strength may be driving a vehicle on a roadway. Sudden inclement weather, such as heavy rain, may cause slowed traffic on the roadway roughly 10 miles ahead of the driver's current location. According to aspects of the present invention, the disclosed ERTCM system may monitor the driver's facial expressions as the vehicle approaches inclement weather. The ERTCM system may integrate information captured from internal and external cameras and other sensors of the vehicle and identify data patterns to identify risks and associated emergency avoidance maneuvers or protocols. For example, when the driver continues to drive toward inclement weather with limited vision capability and physical strength, the driver may be unable to respond to sudden stops, turns, or changes in traffic or weather. The ERTCM system may analyze traffic and weather data, such as expected heavy rain for roughly four hours on a busy highway, and correlate traffic and weather data to interior data, such as the use of facial gestures or perspiration, to profile risk associated with the traffic data, the environmental data, and the interior data. The ERTCM system may identify a risk that the driver will not be able to safely respond to sudden stops in traffic due to low visibility, limited vision capability, and high traffic density. The ERTCM system may identify a contingency maneuver to mitigate or eliminate the risk, such as instructing the driver to pull over and wait for the inclement weather to pass. In some embodiments, the ERTCM system may communicate instructions for the driver to follow other nearby drivers with comparatively better vision capability and physical strength in order to maintain travel while reducing risk.

As a non-limiting example, a vehicle may indicate to a driver that a tire pressure is low in a vehicle. Inclement weather, such as heavy snow, may cause slowed traffic on the roadway roughly 1 mile ahead of the driver's current location. According to aspects of the present invention, the disclosed ERTCM system may monitor the driver's facial expressions or bodily movement or dialogue as the vehicle approaches inclement weather. The ERTCM system may integrate information captured from vehicle sensors and identify data patterns to identify risks and associated emergency avoidance maneuvers or protocols. The ERTCM system may analyze traffic and weather data, and correlate traffic and weather data to interior data, such as use facial gestures or perspiration, to profile risk associated with the traffic data, the environmental data, and the interior data. The ERTCM system may identify a risk that the driver will not be able to safely respond to sudden stops in traffic due to low visibility, limited vision capability, and high traffic density. The ERTCM system may identify a contingency maneuver to mitigate or eliminate the risk, such as instructing the driver to pull over and contact emergency services (e.g., emergency medical services, police, fire and rescue, etc.) to fix or replace the low-pressure tire. In some embodiments, the ERTCM system may contact emergency services systematically to inform emergency services that a vehicle requires aid and provide vehicle identification and location data to emergency services in order to expedite aid.

As an additional non-limiting example, multiple vehicles may experience multiple emergencies of varying significance or risk to the driver's health or safety. For example, a first vehicle may have a flat tire and require repair and a second vehicle may have crashed and the driver is unresponsive. The ERTCM system may integrate information captured from multiple vehicles'sensors and identify data patterns to identify risks and associated emergency avoidance maneuvers or protocols, including prioritization of emergencies. The ERTCM system may identify a contingency maneuver to mitigate or eliminate the risk for the first and second vehicle, such as identifying that the second vehicle's driver cannot perform contingency maneuvers and requires immediate medical aid. In some embodiments, the ERTCM system may contact emergency services systematically to inform emergency services that a vehicle requires aid and provide vehicle identification and location data to emergency services in order to expedite aid. In this way, the ERTCM system may prioritize certain vehicles or emergencies by aggregating vehicle, driver, traffic, and weather data, profile a risks associated with each of the vehicles, identify contingency maneuvers based on the risks; and instruct vehicles to execute the contingency maneuvers or contact emergency services.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as emergency-aware risk treatment and contingency maneuvers (ERTCM) code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

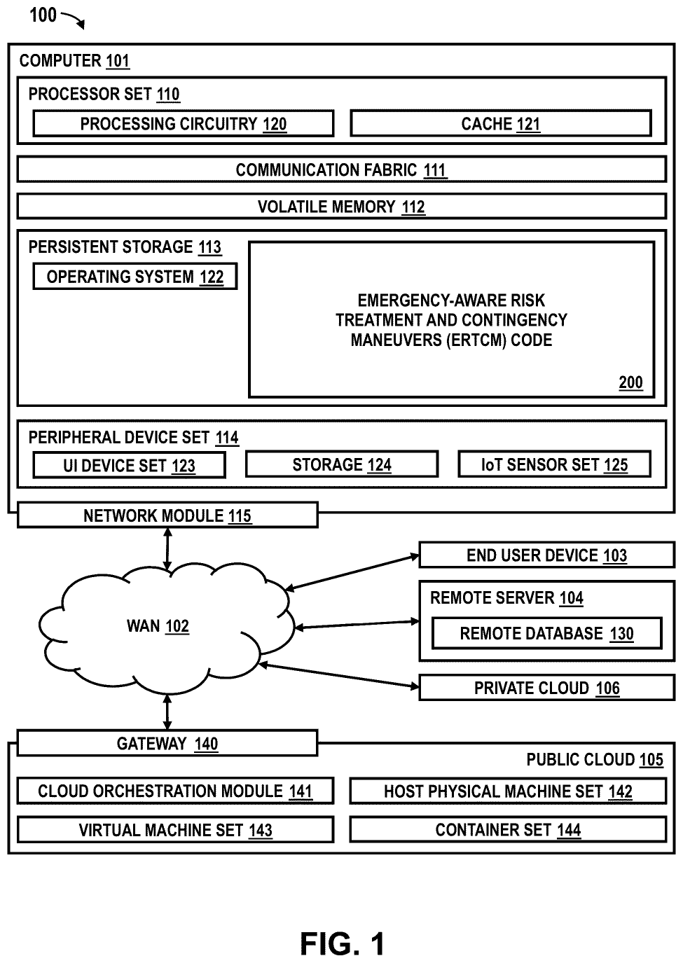

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip. ” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

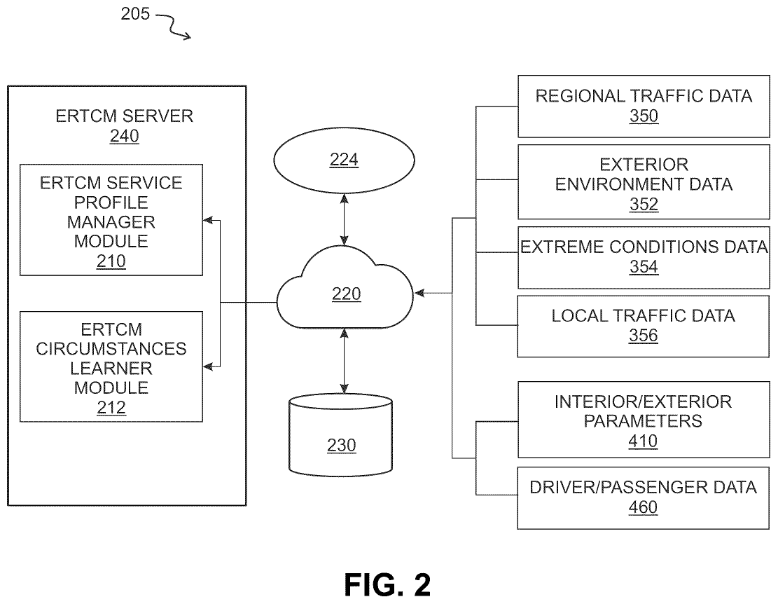

FIG. 2 shows a block diagram of an exemplary environment 205 in accordance with aspects of the invention. In embodiments, the environment includes an ERTCM server 240 corresponding to the computer 101 of FIG. 1. In embodiments, the ERTCM server 240 of FIG. 2 comprises an ERTCM service profile manager module 210 and an ERTCM circumstances learner module 212, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The ERTCM server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

The ERTCM service profile manager module 210 may be configured to receive information from an IoV network 220, corresponding to WAN 102 of FIG. 1 which may be an IoV network, or data measured via onboard vehicle sensors and systems. The ERTCM service profile manager module 210 may be configured to receive information over the IoV network 220, including regional traffic data 350, exterior environment data 352, extreme conditions data 354, and local traffic data 356. Regional traffic data 350 may include traffic volume, speed, crash or accident data, etc., received from traffic monitoring systems and services implementing global positioning satellite systems and services. Exterior environment data 352 may include weather and climate data received from a database, such as database 230 corresponding to a remote database 130 of FIG. 1, or weather monitoring services, such as a national weather service.

Extreme conditions data 354 may include extreme wind conditions, extreme pressure conditions, extreme temperature conditions, extremely low visibility conditions, etc., as determined via weather monitoring services or measured via onboard vehicle sensors. Local traffic data 356 may include traffic volume, speed, crash or accident data, measured locally relative to a vehicle implementing the ERTCM system via onboard vehicle sensors.

The ERTCM circumstances learner module 212 may be configured to receive information from the IoV network 220, including interior/exterior parameters 410 and driver/passenger data 460. Interior/exterior parameters 410, including exterior environment data 352 and interior environmental data 358, may include temperature, humidity, noise, speech data, pressure, temperature, humidity, light, etc., measured internally and externally via onboard vehicle sensors. Driver/passenger data 460 may include driver and passenger count, speech, heart rate, perspiration, etc., measured via onboard vehicle sensors or received through a user interface of a vehicle or user device 224.

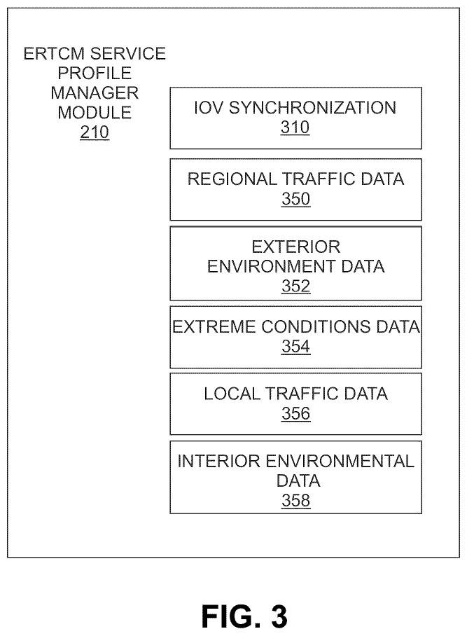

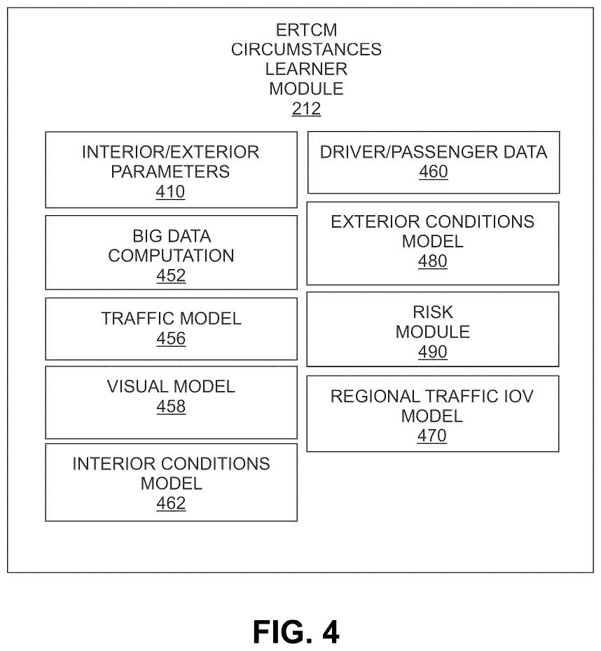

FIG. 3 shows a block diagram of an exemplary environment in accordance with aspects of the present invention. In embodiments, the environment 205 includes the ERTCM service profile manager module 210. Further, in aspects of the present invention, the ERTCM service profile manager module 210 may include IOV synchronization 310, which may be a software module functioning to synchronize IoV data from a plurality of vehicles including large-scale data sensing and measurement, collection, information processing, and storage. The ERTCM service profile manager module 210 may receive the regional traffic data 350, the exterior environment data 352, the extreme conditions data 354, and the local traffic data 356 from the IoV network 220, as described with respect to FIG. 2. The ERTCM service profile manager module 210 may include interior environmental data 358, including vehicle cabin humidity, volume, temperature, etc., measured locally via onboard vehicle sensors and communicated to the ERTCM service profile manager module 210 over the IoV network 220 of FIG. 2. The ERTCM service profile manager module 210 may compile the regional traffic data 350, exterior environment data 352, extreme conditions data 354, local traffic data 356, and interior environmental data 358 into a vehicle profile which may be synchronized with other vehicle profiles in an IoV network 220 to create a database of vehicle profiles. Vehicle profiles may be implemented in big data computation performed by the ERTCM circumstances learner module 212 described below with respect to FIG. 4.

FIG. 4 shows an exemplary environment in accordance with aspects of the present invention. In embodiments, the environment 205 includes the ERTCM circumstances learner module 212, which is configured to determine vehicle contingency maneuvers, generate emergency guidance and assistance strategies, and perform risk reporting to the IoV network 220 of FIG. 2. The ERTCM circumstances learner module 212 may receive interior/exterior parameters 410 and driver/passenger data 460 (regional traffic data, vehicle exterior data, and vehicle interior data) as described with respect to FIG. 2. The ERTCM circumstances learner module 212 may also generate a traffic model 456, visual model 458, interior conditions model 462, exterior conditions model 480, and regional traffic IoV model 470. Alternatively, each of the traffic model 456, visual model 458, interior conditions model 462, exterior conditions model 480, and regional traffic IoV model 470 may be pre-developed computer models. Each of the traffic model 456, visual model 458, interior conditions model 462, exterior conditions model 480, and regional traffic IoV model 470 may be statistical models, machine learning algorithms, simulation models, etc. Statistical models may include, for example, logistic regression, time-series, clustering analysis, hierarchical, or decision tree models. Machine learning algorithms may include, for example, k-nearest neighbor, k-means, Apriori, linear regression, or logistic regression algorithms. Simulation models may include, for example, discrete models, continuous models, or mixed models. The models may be computer-based programs configured to capture or predict outcomes of simulated vehicle, traffic, weather, or driver and passenger behavior based on the interior/exterior parameters 410, driver/passenger data 460, and big data computation 452. In embodiments, the models, including regional traffic IoV model 470, may be generated by associating governing equations with each of the interior/exterior parameters 410 and driver/passenger data 460 and extrapolating future interior/exterior parameters 410 and driver/passenger data 460 in order to identify potential risks. Governing equations may be any rules describing the interaction between variables in the model. For example, interior/exterior parameters 410 and driver/passenger data 460 may indicate clear weather, low traffic, and a driver having slowed heart rate and drooping eyelids (identified via onboard vehicle sensors or cameras). The ERTCM circumstances learner module 212 may extrapolate weather and traffic data to predict that clear weather and low traffic will persist during a drive. Additionally, the ERTCM circumstances learner module 212 may compare historical driver data (average heartrate, historical eyelid movement) to current driver data (slowed heart rate, drooping eyelids) to extrapolate that the driver may be at risk of falling asleep while driving, indicating a risk.

The big data computation 452 may be a software module configured to identify and classify the severity and likelihood of the occurrence of a risk to a target vehicle or driver based on the inputs interior/exterior parameters 410, driver/passenger data 460, and the database of vehicle profiles created by the ERTCM service profile manager module 210. In embodiments, the big data computation 452 may perform, for example, descriptive, predictive, or prescriptive analytics including regression analysis, discourse analysis, cluster analysis, or data mining to classify the severity and likelihood of the occurrence of a risk. In embodiments, the big data computation 452 considers a multitude of vehicle profiles, interior/exterior parameters 410, and driver/passenger data 460 relative to a target vehicle as modeled by the regional traffic IoV model 470 to identify risks associated with driving the target vehicle under certain conditions. For example, the big data computation 452 may receive vehicle profiles of one hundred vehicles in relative proximity to the target vehicle implementing the ERTCM system and compare the vehicle profiles to the interior/exterior parameters 410 and driver/passenger data 460 of the target vehicle to generate a risk analysis matrix. The big data computation 452 may generate a risk analysis matrix by mapping a risk likelihood to a risk severity in a comparison table. Risk module 490 may compare the risk analysis matrix generated from the big data computation 452 to a risk tolerance threshold to identify risks relevant to the target vehicle. For example, the risk module 490 may compare risks within the risk analysis matrix to the risk threshold and risks above the risk threshold may be considered relevant to vehicle, driver, or passenger safety.

The traffic model 456 may be generated via the ERTCM circumstances learner module 212 by receiving traffic data, corresponding to local traffic data 356 of FIG. 2, via the IoV network 220 and real-time visual data from cameras of local vehicles. Traffic information and visual data may be analyzed to establish the traffic model 456. Traffic model 456 may be configured to model and predict traffic changes by extrapolating traffic and visual data in combination with the visual model 458. The visual model 458 may implement visual recognition models, e.g., a convolutional neural network using backpropagation to identify image features, edges, textures, etc., to identify outlines and speeds of other vehicles adjacent to a target vehicle to determine an intention to change lanes, brake urgently, etc.

The interior conditions model 462 may model the internal activity, corresponding to driver/passenger data 460 of FIG. 1, of vehicles, including the physical discomfort of drivers or passengers. The interior conditions model 462 may analyze and summarize the internal activity through smart wearable devices or voice recognition. For example, internal activity includes certain special needs of drivers or passengers, such as physical discomfort of pregnant women, discomfort caused by cardiovascular or cerebrovascular diseases, etc.

The exterior conditions model 480 may be configured to model extreme conditions outside the target vehicle based on the extreme conditions data 354 or interior/exterior parameters 410 of FIG. 2, including the identification and summary of the phenomena of extreme wind conditions, extreme pressure conditions, extreme temperature conditions, extremely low visibility conditions, etc.

In embodiments, model data (e.g., predictions) from the traffic model 456, visual model 458, interior conditions model 462, exterior conditions model 480, and regional traffic IoV model 470 may be communicated to the big data computation 452 to update the regional traffic IoV model 470. The regional traffic IoV model 470 may model regional traffic data to estimate traffic shifts that are not considered local to a target vehicle implementing the ERTCM system. For example, the big data computation 452 may compare vehicle profiles (comprising regional traffic data 350, exterior environment data 352, extreme conditions data 354, local traffic data 356, and interior environmental data 358 of FIG. 3) to the interior/exterior parameters 410 and driver/passenger data 460 of the target vehicle to generate the risk analysis matrix. The risk module 490 may compare the risk analysis matrix to a risk tolerance threshold to identify risks relevant to the target vehicle. In this way, multi-modal big data may be used to model and classify the severity and likelihood of occurrence of various risks and calculate the risk level of model data.

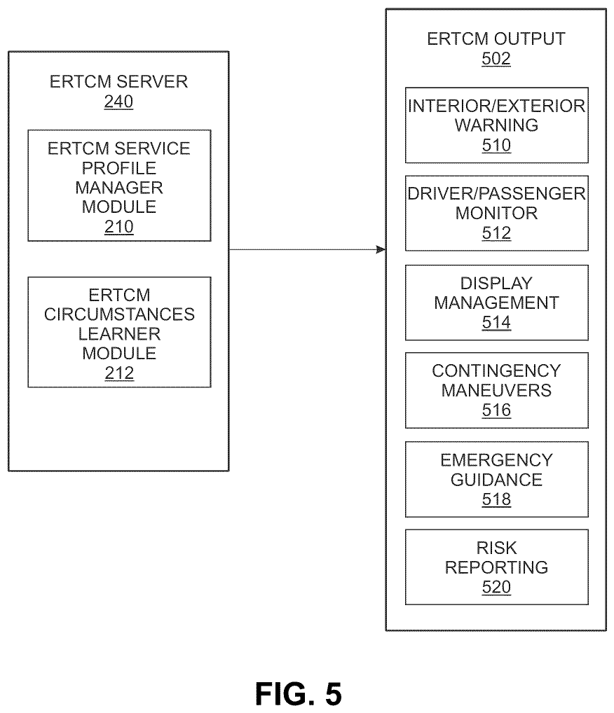

FIG. 5 shows an exemplary environment in accordance with aspects of the present invention. The ERTCM server 240 (corresponding to ERTCM server 240 of FIG. 4), may generate ERTCM output 502 when a risk is above the risk threshold, near the threshold, or when the risk meets predefined conditions. For example, an interior/exterior warning 510 message may be generated and communicated to a user interface of a vehicle or user device 224 of FIG. 2 in response to the ERTCM server 240 determining that the risk of high winds may affect driving. Similarly, a driver/passenger monitor 512 warning may be generated and communicated to a user interface of a vehicle or user device in response to the driver or passenger's perspiration and heart rate being above a pre-defined threshold. The ERTCM server 240 may identify contingency maneuvers using a ruled-based or a table look-up correlation between identified risks and known contingency maneuvers. A table may contain historically known risks and known contingencies maneuvers as solutions, e.g., risks associated with low-tire pressure. In further embodiments, the ERTCM server 240 may link risks to a table or a rule to provide contingency maneuvers to reduce risk associated with low-tire pressure, e.g., pull-over and pressurize tire, or replace tire. Contingency maneuvers 516 may include instructions communicated to a target vehicle that are executable by the target vehicle to reduce risk, e.g., ADAS braking system instructions to decelerate the vehicle. Alternatively, contingency maneuvers 516 may be instructions that are sent to a user interface of a vehicle or a user device to communicate (through text, audio, image, or video) steps for a driver to reduce risk. As an example, contingency maneuvers 516 may include text instructions displayed on a vehicle infotainment system to turn right, left, pull over, or following a specific driving route, etc. Similarly, emergency guidance 518 may be output by the ERTCM output 502. In particular, the emergency guidance 518 may include instructions sent to a user interface of a vehicle or user device to communicate (through text, audio, image, or video) steps for a driver to contact emergency services. In some embodiments, the emergency guidance 518 may include automated emergency service contact. ERTCM output 502 may also include risk reporting 520 of identified risks or risk analysis matrices to the big data computation 452 to improve data modeling performed by any of the traffic model 456, visual model 458, interior conditions model 462, exterior conditions model 480, and regional traffic IoV model 470. In embodiments, display management 314 may be a software module configured to display and manage ERTCM output 502 messages and user input. For example, display management 514 is a software module in operable communication with a vehicle infotainment system as part of the target vehicle.

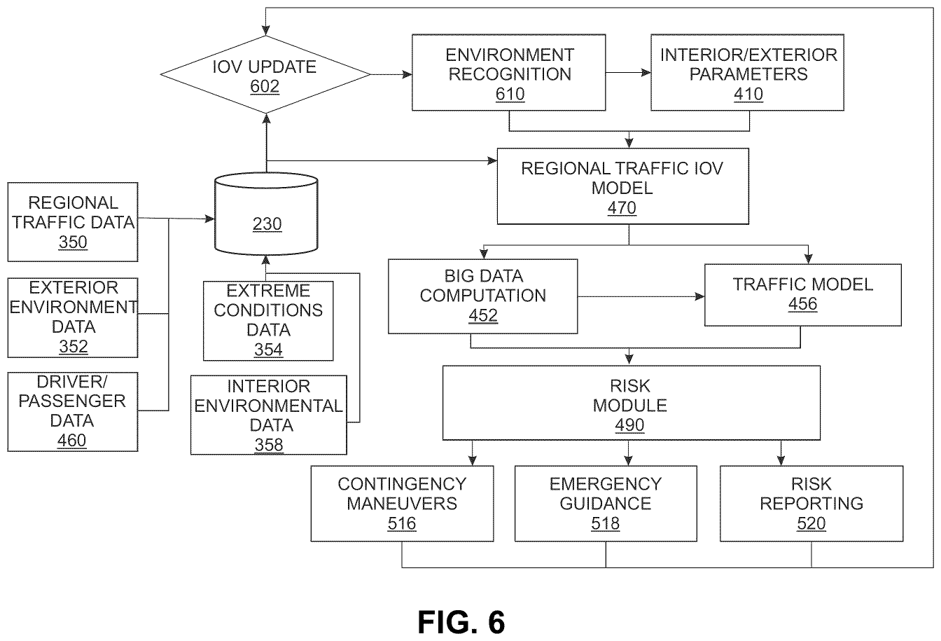

FIG. 6 shows a block diagram of an exemplary method in accordance with aspects of the present invention. Regional traffic data 350, exterior environment data 352, extreme conditions data 354, driver/passenger data 460, and interior environmental data 358 may be communicated to a database 230. In further embodiments, the database 230 may be in communication with the regional traffic IoV model 470 in FIG. 4. The regional traffic IoV model 470 may model regional traffic data based on the regional traffic data 350, exterior environment data 352, extreme conditions data 354, driver/passenger data 460, and interior environmental data 358 to estimate traffic shifts relevant to a target vehicle implementing the ERTCM system. Regional traffic data 350, exterior environment data 352, extreme conditions data 354, driver/passenger data 460, and interior environmental data 358 may be incorporated into IoV update 602 to update the regional traffic IoV model 470 in real time. IoV update 602 may also incorporate real-time visual recognition of nearby vehicles via onboard vehicle sensors and cameras to update the regional traffic IoV model 470. Estimated traffic shifts and real-time visual recognition may be communicated to the big data computation 452 and traffic model 456. The big data computation 452 analyzes a multitude of vehicle profiles and interior/exterior parameters 410 relative to a target vehicle as modeled by the regional traffic IoV model 470 to identify risks associated with driving the target vehicle under certain conditions. Risk module 490 may compare a risk analysis matrix to a risk tolerance threshold to identify risks relevant to the target vehicle. For example, risks above the threshold may be considered relevant to vehicle, driver, or passenger safety. In this way, multi-modal big data may be used to model and classify the severity and likelihood of occurrence of various risks and calculate the risk level of model data. Risk module 490 may output contingency maneuvers 516, emergency guidance 518, or risk reporting 520. Contingency maneuvers 516 may include instructions sent to a target vehicle that are executable by the target vehicle to reduce risk, e.g., ADAS steering system instructions to change lanes. Alternatively, contingency maneuvers 516 may be instructions sent to a user interface of a vehicle or user device to communicate steps for a driver to reduce risk. Similarly, emergency guidance 518 may be output by the ERTCM output 502. In embodiments, the emergency guidance 518 may include instructions sent to a user interface of a vehicle or user device to communicate steps for a driver to contact emergency services. In some embodiments, the emergency guidance 518 may include an automated emergency service contact. Each of the contingency maneuvers 516, emergency guidance 518, or risk reporting 520 may be communicated to the IoV update 602 to update the regional traffic IoV model 470, big data computation 452, or traffic model 456. In this way, the ERTCM server 240 improves data modeling performed by any of the traffic model 456, visual model 458 of FIG. 4, interior conditions model 462 of FIG. 4, exterior conditions model 480 of FIG. 4, and regional traffic IoV model 470.

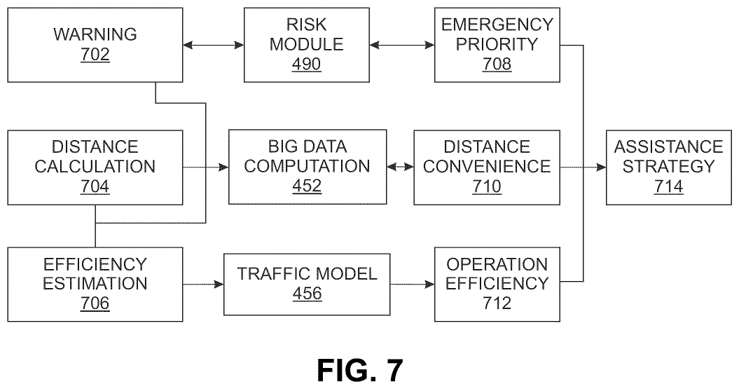

FIG. 7 shows a flowchart of an exemplary method in accordance with aspects of the present invention. The risk module 490 may be configured to prioritize communicating a warning 702 in special emergencies. In embodiments, an assistance strategy 714 may be generated via the big data computation 452 and the traffic model 456, as depicted in FIG. 7. The assistance strategy 714 may include a distance convenience 710 calculated by the big data computation 452 and an operation efficiency 712 determined by the traffic model 456. The distance convenience 710 may be a distance calculation 704 of the nearest emergency service provider to a target vehicle based on GPS location data. The operation efficiency 712 may be an efficiency estimation 706 of the fastest route to the target vehicle based on GPS location data and traffic data, such as regional traffic data 350 and local traffic data 356 of FIG. 2. In embodiments, the risk module 490 makes a ruled-based comparison of the assistance strategy 714 to other assistance strategies determined for other vehicles and contingency maneuvers 516 depicted in FIG. 6 to determine emergency priority 708 per vehicle. For example, an unconscious passenger or driver and corresponding assistance strategy may be prioritized over a low-tire-pressure risk and corresponding assistance strategy. In response to the emergency priority 708 determination, the risk module 490 communicates warning 702 to emergency service providers.

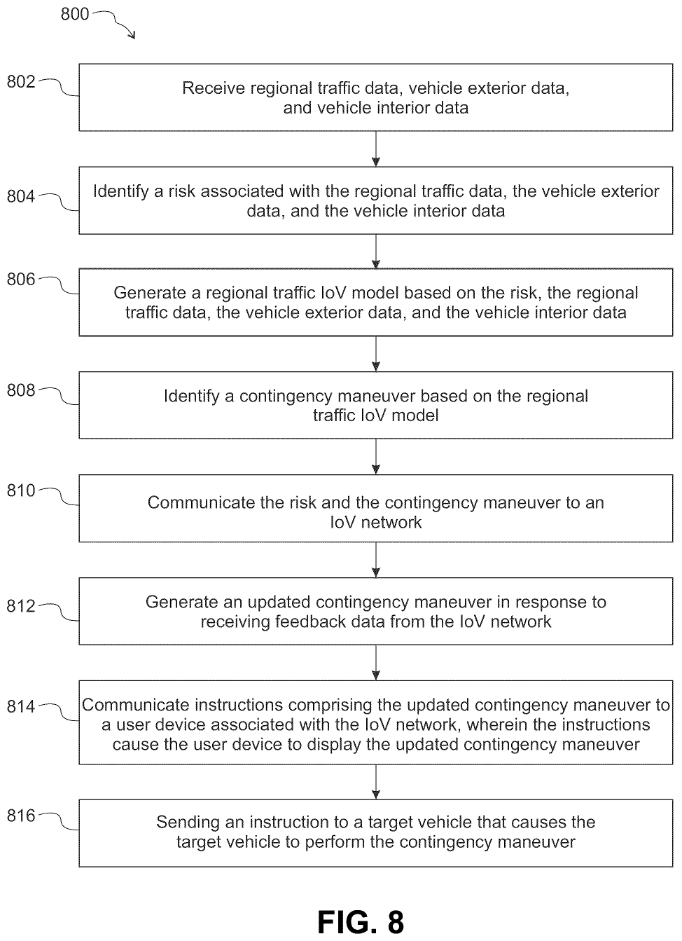

FIG. 8 shows a flowchart of an exemplary method 800 in accordance with aspects of the present invention. In step 802, a computer-implemented method may include receiving regional traffic data, vehicle exterior data, and vehicle interior data via the ERTCM service profile manager module 210 of FIG. 2. In step 804, a computer-implemented method may include identifying a risk associated with the regional traffic data, the vehicle exterior data, and the vehicle interior data via the risk module 490 of FIG. 4. In step 806, a computer-implemented method may include generating a regional traffic internet-of-vehicles (IoV) model based on the risk, the regional traffic data, the vehicle exterior data, and the vehicle interior data via the regional traffic IoV model 470 of FIG. 4. In step 808, a computer-implemented method may include identifying a contingency maneuver based on the regional traffic IoV model via the regional traffic IoV model 470 of FIG. 4. In step 810, a computer-implemented method may include communicating the risk and the contingency maneuver to an IoV network via the risk module 490 of FIG. 4. In step 812, a computer-implemented method may include generating an updated contingency maneuvers in response to receiving feedback data from the IoV network via the risk module 490 of FIG. 4. In step 814, a computer-implemented method may include communicating instructions comprising the updated contingency maneuver to a user device associated with the IoV network, wherein the instructions cause the user device to display the updated contingency maneuver via the risk module 490 of FIG. 4. In step 816, a computer-implemented method may include sending an instruction to a target vehicle that causes the target vehicle to perform the contingency maneuver via the risk module 490 of FIG. 4.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, regional traffic data, vehicle exterior data, and vehicle interior data;
identifying, by the processor set, a risk associated with the regional traffic data, the vehicle exterior data, and the vehicle interior data;
generating, by the processor set, a regional traffic internet-of-vehicles (IoV) model based on the risk, the regional traffic data, the vehicle exterior data, and the vehicle interior data;
identifying, by the processor set, a contingency maneuver based on the regional traffic IoV model;
communicating, by the processor set, instructions comprising the contingency maneuver to a user device associated with the IoV network, wherein the instructions cause the user device to display the contingency maneuver; and
sending, by the processor set, an instruction to a target vehicle that causes the target vehicle to perform the contingency maneuver.

2. The computer-implemented method of claim 1, wherein the regional traffic data comprises regional traffic within a radius relative to the target vehicle.

3. The computer-implemented method of claim 1, wherein the vehicle exterior data is measured by a sensor external to the target vehicle.

4. The computer-implemented method of claim 1, wherein the vehicle interior data is measured by a sensor within an interior of the target vehicle.

5. The computer-implemented method of claim 1, further comprising communicating a message to an emergency service vehicle based on the risk and an updated contingency maneuver.

6. The computer-implemented method of claim 1, further comprising updating the regional traffic IoV model based on an updated contingency maneuver.

7. The computer-implemented method of claim 1, wherein the identifying the risk comprises:
generating a risk analysis matrix based on the regional traffic data, the vehicle exterior data, and the vehicle interior data;
comparing the risk analysis matrix to a risk tolerance threshold; and
identifying one or more risks above the risk tolerance threshold.

8. The computer-implemented method of claim 1, wherein the generating the regional traffic IoV model comprises at least one rule describing the interaction between each of the regional traffic data, the vehicle exterior data, and the vehicle interior data and extrapolating future regional traffic data, the vehicle exterior data, and the vehicle interior data.

9. The computer-implemented method of claim 1, wherein the identifying the contingency maneuver based on the regional traffic IoV model comprises a rules-based correlation between the risk and the contingency maneuver, wherein the rules-based correlation defines the contingency maneuver to minimize the risk.

10. The computer-implemented method of claim 1, wherein the identifying the risk comprises classifying the severity and likelihood of an occurrence of the risk to a target vehicle or driver based on the regional traffic data, the vehicle exterior data, and the vehicle interior data.

11. The computer-implemented method of claim 1, further comprising:
communicating, by the processor set, the risk and the contingency maneuver to an IoV network;
generating, by the processor set, an updated contingency maneuver in response to receiving feedback data from the IoV network; and
communicating, by the processor, instructions comprising the updated contingency maneuver to a user device associated with the IoV network, wherein the instructions cause the user device to display the updated contingency maneuver.

12. A computer program product comprising one or more computer readable storage media having program instructions collectively stored on the one or more computer readable storage media, the program instructions executable to:
receive regional traffic data, vehicle exterior data, and vehicle interior data;
identify a risk associated with the regional traffic data, the vehicle exterior data, and the vehicle interior data;
generate a regional traffic internet-of-vehicles (IoV) model based on the risk, the regional traffic data, the vehicle exterior data, and the vehicle interior data;
identify a contingency maneuver based on the regional traffic IoV model;
communicate instructions comprising the contingency maneuver to a user device associated with the IoV network, wherein the instructions cause the user device to display the contingency maneuver; and
send an instruction to a target vehicle that causes the target vehicle to perform the contingency maneuver.

13. The computer program product of claim 12, wherein regional traffic data comprises regional traffic within a radius relative to the target vehicle.

14. The computer program product of claim 12, wherein the vehicle exterior data is measured by a sensor external to the target vehicle.

15. The computer program product of claim 12, wherein the vehicle interior data is measured by a sensor within an interior of the target vehicle.

16. The computer program product of claim 12, further comprising communicating a message to an emergency service vehicle based on the risk and an updated contingency maneuver.

17. The computer program product of claim 12, further comprising updating the regional traffic IoV model based on an updated contingency maneuver.

18. The computer program product of claim 12, wherein the identifying the risk comprises:
generating a risk analysis matrix based on the regional traffic data, the vehicle exterior data, and the vehicle interior data;
comparing the risk analysis matrix to a risk tolerance threshold; and
identifying one or more risks above the risk tolerance threshold.

19. A system comprising:
a processor set, one or more computer readable storage media, and program instructions collectively stored on the one or more computer readable storage media, the program instructions executable to:
receive regional traffic data, vehicle exterior data, and vehicle interior data;
identify a risk associated with the regional traffic data, the vehicle exterior data, and the vehicle interior data;
generate a regional traffic internet-of-vehicles (IoV) model based on the risk, the regional traffic data, the vehicle exterior data, and the vehicle interior data;
identify a contingency maneuver based on the regional traffic IoV model;
communicate instructions comprising the contingency maneuver to a user device associated with the IoV network, wherein the instructions cause the user device to display the contingency maneuver; and
send an instruction to a target vehicle that causes the target vehicle to perform the contingency maneuver.

20. The system of claim 19, wherein regional traffic data comprises regional traffic within a radius relative to the target vehicle.
